(19) United States
(12) Patent Application Publication
(10) Pub. No.: US 2021/0245231 A1
(43) Pub. Date: Aug. 12, 2021

(54) Textile Machine Tool Part and Method for Producing a Textile Tool

(71) Applicant: Groz-Beckert KG, Albstadt (DE)

(72) Inventors: Jochen Buck, Albstadt (DE); Thomas Goller, St. Johann (DE); Sven Beis, Meßstetten (DE)

(21) Appl. No.: 16/635,782

(22) PCT Filed: Jul. 19, 2018
(86) PCT No.: PCT/EP2018/069662

§ 371 Date: Mar. 31, 2021

(30) Foreign Application Priority Data
Aug. 3, 2017 (EP) 17184753.6

(51) Int. Cl. B21G 1/04; D04B 15/06; D04B 15/10; D04B 27/02; D04B 35/02; D05B 85/12; C25F 3/06; C25D 7/00; C25D 5/36; C25D 3/04

(52) U.S. Cl. CPC B21G 1/04; D04B 15/06; D04B 15/10; D04B 27/02; C25D 3/04; D05B 85/12; C25F 3/06; C25D 7/00; C25D 5/36; D04B 35/02

(57) ABSTRACT

The invention relates to a textile machine tool part (11) that is used in textile processing in a textile machine and to a method for producing same. The textile machine tool part (11) has a tool core (16) made of a core material and is coated, at least in part, with a wear-resistant coating. The wear-resistant coating (17) is applied to a core surface (18) that has a first microstructure (19). The first microstructure (19) is preferably created using electrochemical etching in the core surface (18). The wear-resistant coating (17) applied thereto is preferably applied directly to at least a section of the core surface (18) having the first microstructure (19) using electrochemical deposition and has a layer thickness of a maximum of 20 μm.

The invention relates to a textile machine tool part comprising textile tools such as, for example, machine knitting needles, machine warp knitting needles, machine sewing needles, machine felting needles, machine tufting needles, or system parts of a textile machine such as sinkers, control parts, coupling parts, as well as yarn guide systems or cams, cylinders, and knitting machine dials. Such textile machine tool parts may be provided, for example, in order to come into contact with yarns or threads when processing the latter. They may have a work step for this in which the textile machine tool part comes into contact with a yarn or threads, and may have a holding section with which the textile machine tool part is held, stored, or moved.

Such textile machine tool parts are highly stressed when the textile machine is operating. For example, a textile machine tool part may be subjected to heavy wear if so-called abrasive yarns or threads are processed. During operation of the textile machine, the textile machine tool parts may also be moved by sliding relative to one another, which can also cause wear. Such wear of textile machine tool parts should be kept as minimal as possible in order to increase the service life and efficiency of the textile machine. For this reason, at least sections of textile machine tool parts are provided with a wear-resistant coating.

A textile machine tool part having a chromium coating for reducing wear is known from EP 1 988 200 A1.

DE 44 91 289 T1 describes a method for coating a textile machine tool part using wet plating and dry plating of a surface made of carbon steel. To reduce the roughness of the surface of the carbon steel, the latter is first polished and then the wear-resistant coating is applied.

DE 25 02 284 A1 describes a method for depositing chromium coatings. The core material to which the chromium coating is to be applied is first pretreated with glass powder using wet blasting and then the chromium coating is applied.

Known from EP 0 565 070 A1 is a method for electrodeposition of coatings, wherein during the electrodeposition the electrical variable has an initial pulse and a subsequent pulse in order to first attain nucleus formation of the deposition material using the initial pulse and then to bring about further accretion of deposition material on the initial nucleus using the subsequent pulse.

U.S. Pat. No. 6,478,943 B1 discloses a method for electrochemical deposition, in which method a structured surface is created during deposition by regulating a pulsing current.

The so-called “TOPOCROM” method by TOPOCROM GmbH creates a structured surface having convex, spherical segment-shaped surface regions.

For increasing the hardness of a needle, DE 199 36 082 A1 suggests shot peening the needles before and after the surface coating.

In the method according to WO 2009/035444 A1, during surface coating by electrochemical etching, part of the nanocrystalline coating applied electrochemically previously is removed again in order to obtain a desired surface structure.

The method known from DE 196 35 736 C2 provides that a textile machine tool part is first degreased, an oxide layer is removed, and then the textile machine tool part is coated. Coating is performed using plasma-supported chemical deposition, during which the plasma atmosphere is stimulated by radiation of a radiofrequency, by means of direct current voltage or pulsed direct current voltage, or even with other frequencies

DE 10 2011 119 335 B3 suggests providing a guide channel of a knitting machine with an uneven surface so that a lubricant reservoir and a corresponding lubricant film can form on the surface of the guide channel.

Also known from practice is a so-called “DURALLOY” coat that embodies a pearl structure with convex spherical segment-shaped elevations. Additional coats, such as for example a silver coating, may be applied to this “DURALLOY coat.

There is still a need for optimizing the surface of textile machine tool parts using a method that is as simple as possible. It is therefore the object of the present invention to provide a textile machine tool part having improved surface properties, which textile machine tool part has a long service life and may be produced economically.

This object is attained using a textile machine tool part having the features of patent claim 1, and using a production method having the features of patent claim 12. Patent claim 9 provides an inventive use of this textile machine tool part.

The textile machine tool part has a tool core that comprises a core material. The core material is in particular a metal material or a metal alloy, such as for instance a steel alloy. The core material has a core surface. A microstructure is present, in at least one section of this core surface. The microstructure has depressions and elevations that are connected to one another. The depressions are embodied depressed in a concave manner when viewing the core surface compared to a reference plane, while the elevations are raised in a convex manner compared to this reference plane. The diameter of a depression and/or elevation may be, for example, a maximum of 50-60 μm. The distance between the minima of the depressions and the maxima of immediately adjacent elevations is preferably a maximum of 40-60 μm and at least of 10-20 μm.

A wear-resistant coating is applied directly to at least one section of the core surface provided with the microstructure. There are no intermediate coatings between the core surface and the wear-resistant coating. The wear-resistant coating applied has a layer thickness of a maximum of 20 μm and preferably a maximum of 10 μm or more preferably a maximum of 7 μm. Due to the microstructure of the core surface, the wear-resistant coating also has a microstructure, wherein the dimensions of the depressions and elevations are in particular smaller than those of the microstructure of the core surface.

Due to the shape of the microstructure on the core surface and the direct application of the wear-resistant coating with a layer thickness of a maximum of 20 μm, a microstructure is embodied there, as well. The dimensions of the depressions and elevations of the microstructure of the wear-resistant coating depend on the dimensioning of the depressions and elevations of the microstructure of the core surface. The surface or outer surface of the wear-resistant coating may therefore be defined using appropriate dimensioning. In this way very specifically desired microstructures on the surface of the wear-resistant coating may be set, especially if the microstructure of the core material is created using electrochemical etching. In addition, due to the microstructuring of the core surface, a good adhesive bond is created between the wear-resistant coating and the core material, which bond maintains good adhesion of the wear-resistant coating on the core material even if fine cracks form in the wear-resistant coating, and minimizes flaking of the wear-resistant coating.

The surface structure of the wear-resistant coating is adapted to the different textile applications and to the special yarns or threads used. In general, the surface structure leads to a reduced contact surface between the yarn or threads. With eye needles, for example, it is particularly advantageous in terms of wear on the eye needles when elastic yarns or threads are used. Because of the reduced contact length, less tension builds in the elastic yarns or threads, which tension increases the wear on the eye needles but can also lead to damage to the yarns or threads themselves.

In addition, due to the very thin coating, the geometry of the thread or yarn-guiding tools is not significantly affected. For example, when there are very small notches (a few hundredths of a millimeter) on felting needles, such a thin coating does not have any effect on the notch during thread transport. However, the needle and the threads are less stressed due to the structure of the coating and the associated reduction in the contact surface. Since when there are such small formed structures, the coating growth cannot be independently controlled at all locations (a notch), the thin coatings are even more advantageous because the effects of locally different coating growth are less important in thinner coatings. In filigree textile tools, the known structured coatings are not suitable due to the required minimum layer thicknesses. In the case of eye needles, the rounding in the hole is less than approx. 100 μm, which would still lead to bulges in thicker coatings (greater than 20 μm). Conditions are similar at the eye of the needle and at the grooved edges of sewing needles.

It is preferred when the layer thickness of the wear-resistant coating is essentially constant and varies by a maximum of 1 μm and/or by a maximum of 10% within an observed surface having an area of 1 mm² (preferably 1 mm×1 mm).

The layer thickness of the wear-resistant coating is at least 1 μm. This minimum layer thickness may decrease in an edge zone in which the wear-resistant coating transitions into an uncoated section of the tool core. The minimum layer thickness is attained at every point outside of this edge zone.

In one preferred exemplary embodiment, the wear-resistant coating is formed by a chromium coating, preferably a hard chromium coating. The wear-resistant coating may also be formed by a DLC coating or a carbidic coating or a nitridic coating. Other available hard material coatings, such as e.g. oxidic carbon nitridic, or oxynitridic hard material coatings may also advantageously be used for the wear-resistant coating. It may also be advantageous to apply wear-resistant coatings made of different materials to different sections of the tool core.

In one preferred embodiment, the microstructure of the wear-resistant coating has elevations (mountains) and/or depressions (valleys) that each have their approximately spherical segment-shaped contour in the region of their maximum or minimum. It is furthermore preferred when a section through the microstructure has a constant curve, the first derivative (slope) of which is likewise constant at every point. In this embodiment it is also possible for the mean radius of a spherical surface section-shaped contour of an elevation to be larger or smaller than the mean radius of a spherical surface section-shaped contour of a depression.

The textile machine tool part may preferably be used in textile machines during the processing of elastane yarns, for instance in swimwear. The fineness of the elastane yarn is preferably in the range of about 20 den (22 dtex) to 40 den (44 dtex). Such yarns are very fine. For example, the diameter of an elastane yarn with a fineness of 22 dtex is approx. 0.04 mm.

A textile machine tool part, in particular according to the description in the foregoing, may be produced using a method having the following steps:

First, a tool core is produced in the desired shape from a core material. Then, a microstructure is created, on at least one section of the core surface. A wear-resistant coating that has a maximum layer thickness of 20 μm is then applied directly to a section of the core surface that has the microstructure.

The microstructure is preferably created using an electrochemical etching method, especially in that the tool core is dipped in a bath and the anode forms, while the solution (for example, chromic acid solution or another inorganic or organic acid or base) of the bath is the cathode, so that core material is released from the tool core and migrates into the bath. The wear-resistant coating is preferably produced, especially using electrochemical deposition, immediately after the microstructure has been created on the core surface. After the microstructure has been created, the tool core may be dipped into a bath (especially a chromium bath) without any intermediate step, such as drying, and act as a cathode, so that chromium deposits on the core surface. The two electrochemical methods are conducted “wet in wet,” so to say. Two different bath devices are preferably used for these two method steps.

The microstructure may also be created using shot peening or other chemical and/or physical and/or mechanical methods.

Additional advantageous embodiments of the textile machine tool and of the method for producing it result from the dependent patent claims, the description, and the drawings. Preferred embodiments of the invention shall be explained in detail in the following, using the attached drawings:

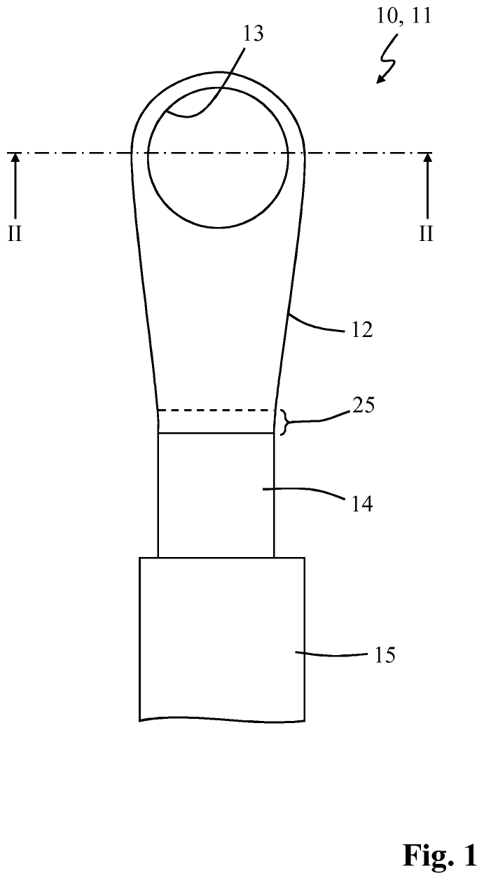

FIG. 1 depicts a side view of an example of a textile machine tool part that is formed by an eye needle;

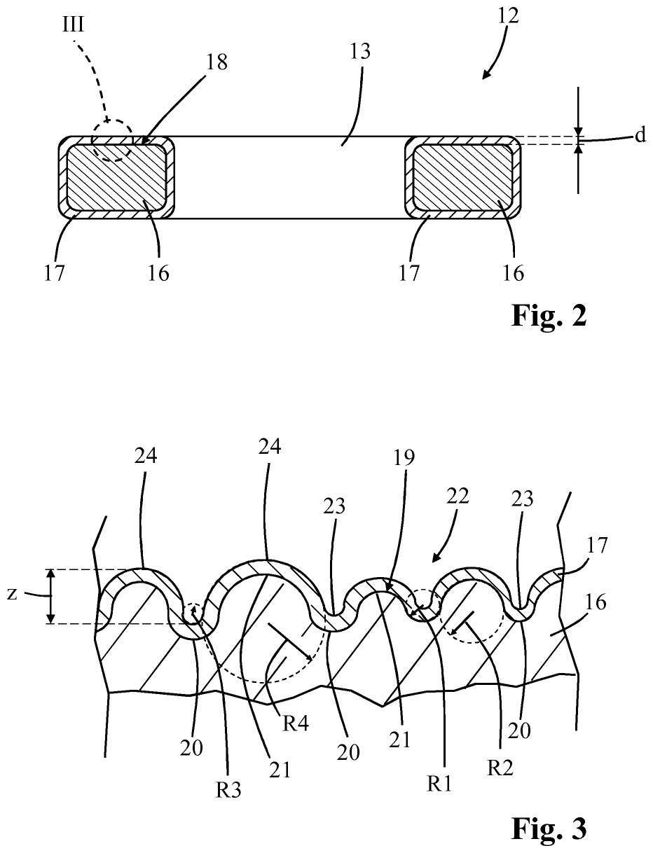

FIG. 2 is a partial sectional view of the eye needle from FIG. 1, according to section line II-II in FIG. 1;

FIG. 3 is a schematic depiction of a sub-region III in FIG. 2 and illustrates a part of the tool core and the wear-resistant coating applied thereto in a highly simplified sectional depiction;

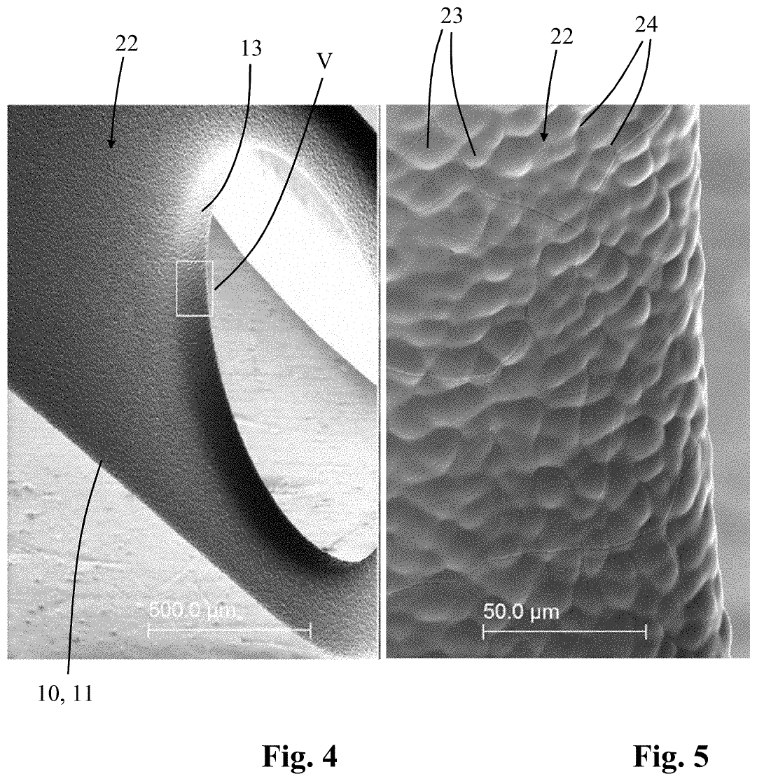

FIG. 4 provides a perspective photographic partial depiction of the eye needle from FIG. 1 and illustrates a wear-resistant coating having a microstructure;

FIG. 5 illustrates a sub-region IV of the wear-resistant coating of the eye needle from FIG. 4; and,

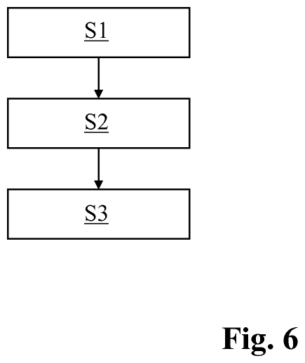

FIG. 6 is a flow chart of an exemplary method for producing a textile machine tool part, for instance of the eye needle according to FIGS. 1-5.

FIG. 1 is a schematic side view of an eye needle 10 that forms a textile machine tool part 11. Another needle, such as, for example, a machine knitting needle, a machine sewing needle, a machine felting needle, or a machine tufting needle, may also form the textile machine tool part instead of an eye needle 10. Instead of being formed by a needle, the textile machine tool part may also be formed by a system part of a textile machine, for example, a sinker, a thread guide system part, or a control or coupling part. A textile machine tool part is in particular a tool part or system part that is attached to the textile machine and that is present in the textile machine for processing threads or yarns and that may come into contact with the yarn or threads, for instance during operation.

The eye needle 10 according to the example has a working section 12 in that the eye needle 10 has an eye 13 for guiding a thread or yarn. A holding section 14 by means of which the eye needle is attached to a needle holder 15 is connected to the eye 13 at the working section 12. As a rule, a plurality of eye needles 10 with aligned eyes 13 are arranged in such a needle holder 15.

Other textile machine tool parts or textile tools also have a working section 12 and a holding section 14. For example, a machine sewing needle or a machine felting needle has working section having the needle tip and has a holding section in the region of the needle shaft, by means of which holding section the needle is held in the machine. A knitting machine needle has a working section with the needle hook and at an interval therefrom has a holding section having a foot part or the like by means of which the machine knitting needle may be moved in a guide channel of the knitting machine, for example. Sinkers or other system parts may have a working section, which comes into contact with a yarn, and a holding section by means of which the part is borne or fixed or caused to move.

FIG. 2 illustrates a partial cut-away depiction according to the line of intersection II-II through the eye 13 (see FIG. 1). It may be seen that the eye needle 10 has, at least in the working section 12, a tool core 16 made of a core material and has a wear-resistant coating 17 that is made of a material that differs from the core material and that is applied directly to the tool core 16. The core material is preferably formed by a metal or a metal alloy and comprises a steel allow, for example. The wear-resistant coating 17 in the exemplary embodiment is formed by a hard chromium coating. It may alternatively be a DLC coating, a carbidic coating, or a nitridic coating.

The wear-resistant coating 17 is applied, for example, only in the working section 12 of the eye needle 10 or of the textile machine tool part 11. Other regions, for example the holding section 14, are not covered with the wear-resistant coating 17. Depending on the precise function of the specific textile machine tool part, it may be sufficient merely to provide the wear-resistant coating 17 only to a section that is subject to wear. However, it is also possible to coat the entire textile machine tool part 11 with the wear-resistant coating 17.

The wear-resistant coating 17 is applied directly to the core material of the tool core 16 without any intermediate coating. A core surface 18 of the core material 16 has a first microstructure 19 in the section in which the wear-resistant coating 17 is applied. The first microstructure 19 is illustrated, in a highly schematic depiction, in FIG. 3, which depicts an enlarged excerpt (Region III in FIG. 2) of the core material and wear-resistant coating 17. The depiction in FIG. 3 is highly simplified and not to scale. As may be seen, the first microstructure 19 is formed on the core surface 18 by adjacently arranged concave first depressions 20 and convex first elevations 21. The depressions 20 and/or the first elevations 21 preferably have a spherical segment-shaped, spherical contour, each having a radius Ri, wherein i represents an index that describes the allocation of the particular radius to a specific first depression 20 or first elevation 21. For example, FIG. 3 illustrates a first radius R1 for a first depression 20 and a second radius R2 for a first elevation 21.

The wear-resistant coating 17 is applied to this first microstructure 19. The layer thickness d of the wear-resistant coating 17 is at least 2 μm and a maximum of 20 μm. In additional exemplary embodiments, the layer thickness d of the wear-resistant coating 17 may also be a maximum of 10 μm or a maximum of 7 μm.

Because of this layer thickness d of the wear-resistant coating 17, the latter also embodies a microstructure, which here is called the second microstructure 22. Analogous to the first microstructure 19, the second microstructure 22 thus forms second depressions 22 and second elevations 24 that are connected to one another. Analogous to the first microstructure 19, the second depressions 23 and the second elevations 24 each have a spherical segment-shaped contour with a radius Ri, wherein in FIG. 3, as an example, a third radius R3 is recorded for a second depression 23 and a fourth radius R5 is recorded for a second elevation 24.

Seen in a section through the first microstructure 19 of the core surface 18 and of the second microstructure 22 of the wear-resistant coating 17 (FIG. 3), the sectional contour lines of the microstructures 19, 22 have a constant course. Their slope (first derivative) is also preferably constant at each point of the curve of the sectional contour lines of the microstructures 19 and 22.

In a modification to the schematic embodiment according to FIG. 3, it is also possible for only the depressions 20 and 23 or only the elevations 21 and 24 of the specific microstructure 19 and 22 to have a spherical segment-shaped form. The radii of the first and second depressions 20, 23 and/or those of the first and second elevations 21, 24 may vary in a prespecified region and may be, for instance, a maximum of 20-30 μm and a minimum of 5-10 μm. An interval z of a minima of a second depression 23 from the maximum of the immediately adjacent second elevations is preferably a maximum of 40-60 μm and a minimum of 10-20 μm.

The layer thickness d of the wear-resistant coating 17 is essentially constant. Within a specific surface having the surface area of 1 mm², preferably a square surface of 1 mm×1 mm, the layer thickness d deviates a maximum of 10% or a maximum of 1 μm. The figures for the layer thickness d apply for the entire wear-resistant coating 17 outside of an edge zone 25 immediately adjacent to an edge 26 of the wear-resistant coating 17. Within this edge zone 25, the layer thickness d decreases continuously to the edge 26 of the wear-resistant coating.

FIG. 4 and FIG. 5 are photographs of the second microstructure 22 of the wear-resistant coating 17. In this exemplary embodiment, only the second elevations 24 have a spherical segment-shaped contour in the region of their maximum, but not the depressions 23.

One preferred method for producing a textile machine tool part 11 and, as an example, the eye needle 10 described in the foregoing is described in the following using FIG. 6.

In a first method step S1 the tool core 16 is produced from core material, for example by molding and/or mechanically processing a core material. The tool core 16 acquires the appropriate shape that determines the shape of the later textile machine tool part 11 and, for example, the eye needle 10.

Then, in a second method step S2, at least in one section of the core surface 18 of the tool core 16, the first microstructure 19 is created, for example using an electrochemical etching process. For this, a chromic acid solution having 50-300 g chromium trioxide per liter at a temperature of 20° C. to 60° is used. The dwell time of the tool core 16 in the bath, depending on the depth or height of the first depressions 20 and first elevations 21 to be produced, is between 10 seconds up to 1800 seconds. The tool core 16 is used as the anode (positive pole of the voltage), so that core material on the core surface is removed and migrates into the electrolytic solution. Less soluble components of the structure of the core material migrate less rapidly into the solution. When etching the first microstructure 19, for example, a current density of 20-40 A/dm² may be used, wherein the etching duration is preferably 30 seconds to 1200 seconds. The desired first microstructure 19 may be dimensioned using the etching duration and the current density.

Since the first microstructure is created using an etching process, immediately after the second method step S2, the wear-resistant coating 17 may be applied “wet in wet” in a third method step S3. There is no drying and there are no other intermediate steps during the second method step S2 or during the third method step S3, for example. In the exemplary embodiment, a hard chromium coating is applied as the wear-resistant coating 17 using electrochemical deposition. At least one section of the tool core 16 having the first microstructure 19 is dipped into an electrolytic bath, wherein the tool core 16 acts as cathode (negative pole) so that material from the bath deposits on the core surface 18 with the first microstructure 19. The bath contains, for example, 170-270 g chromium trioxide per liter, 0.5-2.5% by weight sulfuric acid, and a special catalyst. The special catalyst may be, for example, a sulfonic acid and may have a concentration in the range of 1:10-1:20 relative to the chromium trioxide content of the chromium bath. The temperature of the bath is 50° C. to 70° C. Methane sulfonic acid, dimethanesulfonic acid, or naphthalene sulfonic acid may be used as the sulfonic acid. The current density is 15-50 A/dm², for example. The dwell time in the electrolytic bath is selected such that the wear-resistant coating 17 has a layer thickness of a maximum of 20 μm or a maximum of 10 μm and preferably a maximum of 7 μm. The minimum layer thickness is 1 μm. During the process of coating with the wear-resistant coating 17 using electrochemical deposition, the form of the second microstructure 22 may be influenced by a pulsed current, the current density, temperature, bath concentration, and other parameters. The second microstructure 22 depends on the aforesaid coating parameters and also on the dimensioning and embodiment of the first microstructure 19 on the core surface 18. For instance, elevations and depressions(mountains and valleys) of the second microstructure 22 may be formed that have hemispherical contours.

The invention relates to a textile machine tool part 11 that is used in textile processing in a textile machine, and to a method for producing same. The textile machine part tool 11 has a tool core 16 made of a core material that is coated, at least in part, with a wear-resistant coating. The wear-resistant coating 17 is applied to a core surface 18 that has a first microstructure 19. The first microstructure 19 is preferably created using electrochemical etching in the core surface 18. The wear-resistant coating 17 applied thereto is preferably applied, at least in sections, immediately to the cores surface 18 having the first microstructure 19 using electrochemical deposition and has a layer thickness of a maximum of 20 μm.

### REFERENCE LIST

10 Eye needle
11 Textile machine tool part
12 Working section
13 Eye
14 Holding section
15 Needle holder
16 Tool core
17 Wear-resistant coating
18 Core surface
19 First microstructure
20 First depression
21 First elevation
22 Second microstructure
23 Second depression
24 Second elevation
25 Edge zone
26 Edge
d Layer thickness
Ri Radius
R1 First radius
R2 Second radius
R3 Third radius
R4 Fourth radius
S1 First method step
S2 Second method step
S3 Third method step
z Interval

1. A textile machine tool part (11) having a tool core (16) that consists of a core material,
wherein the tool core (16) has a core surface (18) having a microstructure (19), at least in one section,
wherein the core surface (18) having the microstructure (19) is coated, at least in part, with a wear-resistant coating (17) that has a layer thickness (d) of at most 20 μm and wherein the wear-resistant coating (17) also has a microstructure (22) due to the microstructure (19) of the core surface (18).

2. The textile machine tool part according to claim 1, characterized in that the layer thickness (d) of the wear-resistant coating (17) is at most 10 μm or at most 7 μm.

3. The textile machine tool part according to claim 1 or 2,
characterized in that the layer thickness (d) of the wear-resistant coating (17) within a considered surface area of 1 mm² varies by a maximum of 1 μm.

4. The textile machine tool part according to any of the preceding claims,
characterized in that the layer thickness (d) of the wear-resistant coating (17) is at least 2 μm.

5. The textile machine tool part according to any of the preceding claims,
characterized in that the wear-resistant coating (17) is a chromium coating or a DLC coating or a carbidic coating or a nitridic coating.

6. The textile machine tool part according to any of the preceding claims,
characterized in that the core material is formed from a metal material or a metal alloy.

7. The textile machine tool part according to any of the preceding claims,
characterized in that the microstructure (19) of the core surface (18) and/or the microstructure (22) of the wear-resistant coating (17) has elevations (21, 24) and depressions(20, 23), wherein the elevations (21, 24) in the region of their maximum, and/or the depressions (20, 23) in the region of their minimum, have an approximately spherical surface segment-shaped contour.

8. The textile machine tool part according to claim 7, characterized in that the radius (R2, R4) of a spherical surface segment-shaped contour of a first or second elevation (21, 24) is greater than the radius (R1, R3) of a spherical surface segment-shaped contour of a first or second depression (20, 23).

9. A use of the textile machine tool part (10) according to any of the preceding claims in a textile machine during a method for producing or processing a textile material with at least one elastane yarn that comes into contact with the textile machine tool part (10).

10. The use of the textile machine tool part (10) according to claim 9,
characterized in that the fineness of the at least one elastane yarn is at least 20 den or 22 dtex.

11. The use of the textile machine tool part (10) according to claim 9 or 10,
characterized in that the fineness of the at least one elastane yarn is at most 40 den or 44 dtex.

12. A method for producing a textile machine tool part having the following steps:
Production of a tool core (16) from a core material,
Creation of a microstructure (19) in at least one section of the core surface (28) of the tool core (16),
Coating of at least part of the core surface (18) having the microstructure (19) with a wear-resistant coating (17) that has a layer thickness (d) of at most 20 μm such that the wear-resistant coating (17), due to the microstructure (19) of the core surface (18), also has a microstructure (22).

13. The method according to claim 12,
characterized in that the microstructure (19) is created in the core surface (18) using an electrochemical etching process.

14. The method according to claim 12 or 13,
characterized in that the wear-resistant coating (17) is applied immediately after the microstructure (19) of the core surface (18) is created.

15. The method according to any of claims 12 through 14, characterized in that coating with the wear-resistant coating (17) is accomplished using electrochemical deposition.
